(19) United States
(12) Patent Application Publication
(10) Pub. No.: US 2022/0050761 A1
(43) Pub. Date: Feb. 17, 2022

(54) LOW OVERHEAD PERFORMANCE DATA COLLECTION

(71) Applicant: Core Scientific, Inc., Bellevue, WA (US)

(72) Inventors: Max Alt, San Francisco, CA (US); Paulo Roberto Pereira de Souza filho, Maringa (BR)

(21) Appl. No.: 17/400,584

(22) Filed: Aug. 12, 2021

Related U.S. Application Data
(60) Provisional application No. 63/064,616, filed on Aug. 12, 2020.

(51) Int. Cl. G06F 11/30; G06F 11/34; G06F 11/07; G06F 11/32

(52) U.S. Cl. CPC G06F 11/3096; G06F 11/3428; G06F 2201/88; G06F 11/076; G06F 11/324; G06F 11/3082

(57) ABSTRACT

Systems and methods for collecting performance data in high performance computing systems are disclosed. To prevent massive amounts of performance data from overwhelming the system and negatively impacting performance, collected performance data may be processed into two databases: (i) an aggregate database, and (ii) a time-series database holding the newest information for real time performance analysis. Storage space may be saved by using a FIFO buffer to store collected performance data. A real-time performance collection engine may adjust the performance sampling interval used and the particular performance counters used based on measured system impact and feedback from other system modules consuming the performance data.

### CROSS-REFERENCE TO RELATED APPLICATIONS

This application claims the benefit of, and priority to, U.S. Provisional Application Ser. No. 63/064,616, filed Aug. 12, 2020, titled “LOW OVERHEAD PERFORMANCE DATA COLLECTION”, the disclosure of which is hereby incorporated herein by reference in its entirety and for all purposes.

### TECHNICAL FIELD

The present disclosure generally relates to the field of computing and, more particularly, to systems and methods for estimating and predicting application performance in computing systems.

### BACKGROUND

This background description is set forth below for the purpose of providing context only. Therefore, any aspect of this background description, to the extent that it does not otherwise qualify as prior art, is neither expressly nor impliedly admitted as prior art against the instant disclosure.

Since the dawn of computing, there has always been a need for increased performance. For modern high-performance workloads such as artificial intelligence, scientific simulation, and graphics processing, performance is particularly important. These high-performance computing (HPC) applications (also called workloads or jobs) can take many hours, days or even weeks to run, even on state-of-the-art high-performance computing systems with large numbers of processors and massive amounts of memory. In many cases, these applications are created by specialists (e.g. data scientists, physicists) that are focused on solving a problem (e.g. performing image recognition, modeling a galaxy). They would rather spend their time creating the best solution for their problem, rather than spending time laboriously instrumenting code and then performing manual optimizations, which is a currently a common method for improving the performance of applications.

To improve performance, the developer of an application must select one or more performance tools that can be run on the system with the application in order to log performance data. Examples include the Linux perf tool for CPU, memory, I/O and other performance data, 1trace for tracing system libraries, netstat for network performance, vmstat for memory and virtual memory performance monitoring, iostat for I/O tracing, etc. A large amount of data can be collected by these and other tools, either alone or in combination. Performance data collected may include for example CPU performance counters, instructions per second counters, cache-miss counters, clock cycle counters, branch miss counters, etc. Once one or more performance monitoring tools are selected, they must be configured (e.g., selecting what data to sample and how often to sample it). The performance data must then be interpreted by the developer in order to figure out what code or system configuration changes should be made.

Collecting all of this performance data can be overwhelming. In many cases, running these traditional performance profiling tools regularly on large HPC jobs is not possible due to the overhead involved. For example, capturing data on 10,000 MPI processes over one week using 100 counters with a one minute interval can produce a large number of data points (e.g., [10,000 procs]×[7 days]×[24 hours]×[60 min]×[100 counters] is over 10 billion data items). Even sampling every few hundred clock cycles for a short period of time can generate very large amounts of data. This can negatively impact performance (i.e., the performance monitoring itself negatively impacts performance because the system must devote significant resources to generating and processing the requested performance data). Once the data is generated, sorting through it to determine areas for performance enhancement is a difficult task and can require significant time and expertise.

However, since most performance profiling is a statistical sampling process, common wisdom dictates that enough individual samples must be collected to produce statistically meaningful results and to reduce measurement error. So simply reducing the amount of data by increasing the interval or collecting fewer data points would not normally be desirable. Determining how to strike the proper balance between collecting enough data (i.e., resolution) but not so much as to slow down performance is difficult and time consuming. For these reasons, a better method for collecting and handling performance data is desired.

### SUMMARY

An improved system and method for light-weight real-time collecting of performance data in high-performance computing systems is contemplated. Performance data generated by one or more performance profiling tools from multiple runs of multiple different applications on multiple different systems is stored into a database. To prevent massive amounts of data from overwhelming the system, the data is aggregated, and the performance profiling tools receive feedback from one or more modules indicating when to increase resolution and decrease resolution and which performance data to collect and which performance data should not be collected. These modules may include for example, a real-time performance analysis engine, a recommendation engine, a system health monitor, and a system security monitor. This may permit new uses for performance data that has typically only been used sporadically for performance optimization. For example, a system health monitor or system security monitor may dynamically request the performance monitoring.

In one embodiment, the collected performance data is processed into two databases: (i) an aggregate database, and (ii) a time-series database holding the newest information for real time performance analysis. Storage space may be saved by using a FIFO buffer between the performance data collection module and data collection module.

In one embodiment, the method for managing performance data may comprise executing a performance profiling tool on a computing system, executing an application on the computing system, collecting performance data about the application from the performance profiling tool, and storing the performance data in a database. The impact of the performance profiling tool on the application may be monitored, and the interval at which the performance profiling tool operates may be adjusted (e.g., to keep the impact of the performance profiling tool on the application below a predetermined policy threshold such as 1%).

In some embodiments, the performance data may be provided to one or more system monitors, and feedback may be received from the system monitors. The interval at which the performance profiling tool operates may be adjusted based on that feedback and one or more performance measures may be added or removed from being collected based on the feedback. For example, one of the system monitors may be a system health monitor or a system security monitor.

In some embodiments, recommendations may be provided to users regarding application optimizations based on the performance data stored in the database, some of which may be aggregated.

In another embodiment, the method for estimating performance on cloud computing systems may comprise executing a plurality of performance benchmarks on a plurality of cloud computing systems and bare metal computing systems to collect performance counter data, storing the performance counter data into a FIFO buffer, reading the performance counter data out of the FIFO buffer, storing a time-limited window of the performance counter data into a time-series database, aggregating the performance counter data, and storing the aggregated performance counter data into an aggregated database.

In some embodiments, real-time performance analysis may be performed on the performance counter data in the time-series database and the aggregated database, and recommendations may be made to users based on the performance counter data in the time-series database and the aggregated database. The real-time performance analysis may for example include creating histograms of the performance counter data.

The performance counter data may comprise a set of normally available counters and one or more normally unavailable counters. Users may be provided with access to the time-series database and the aggregated database simultaneously for real-time and aggregated performance analysis. The performance counter data may for example comprise instruction counters, cycle counters, page-faults, and context-switches.

The methods may for example be implemented in software, such as on a non-transitory, computer-readable storage medium (e.g., DVD, flash-based SSD, or disk drive) storing instructions executable by a processor of a computational device (e.g., a PC, server, or virtualized computing device).

The foregoing and other aspects, features, details, utilities, and/or advantages of embodiments of the present disclosure will be apparent from reading the following description, and from reviewing the accompanying drawings.

### BRIEF DESCRIPTION OF THE DRAWINGS

FIG. 1 is an illustration of one example of a distributed computing system.

FIG. 2 is a flowchart of an example embodiment of a method for estimating application performance on cloud computing systems.

FIG. 3 is an illustration of an example histogram of performance counter data.

FIG. 4 is a flowchart of an example embodiment of a method for recommending a cloud configuration based on estimated performance counters.

FIG. 5 is a flowchart of an example embodiment of a method for estimating relative cloud system performance.

FIG. 6 is a flowchart of an example embodiment of a method for providing relative performance estimates for cloud and bare metal configurations.

FIG. 7 is a diagram illustrating an example of a matrix usable for estimating performance for cloud and bare metal systems.

FIG. 8 is a flowchart illustrating an example of one embodiment of a scalable method for collecting performance data in a high-performance computing system.

### DETAILED DESCRIPTION

Reference will now be made in detail to embodiments of the present disclosure, examples of which are described herein and illustrated in the accompanying drawings. While the present disclosure will be described in conjunction with embodiments and/or examples, it will be understood that they do not limit the present disclosure to these embodiments and/or examples. On the contrary, the present disclosure covers alternatives, modifications, and equivalents.

Various embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

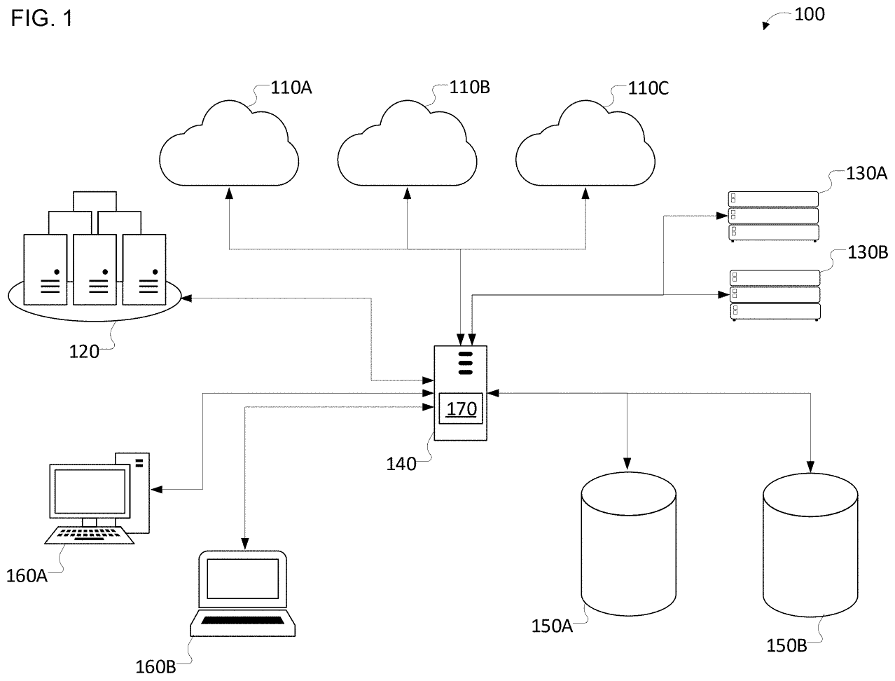

Turning now to FIG. 1, an example of a distributed computing system 100 is shown. In this example, the distributed computing system 100 is managed by a management server 140, which may for example provide access to the distributed computing system 100 by providing a platform as a service (PAAS), infrastructure as a service (IAAS), or software as a service (SAAS) to users. Users may access these PAAS/IAAS/SAAS services from their on-premises network-connected servers, PCs, or workstations (160A) and mobile devices such as laptops (160B) via a web interface.

Management server 140 is connected to a number of different computing devices via local or wide area network connections. This may include, for example, cloud computing providers 110A, 110B, and 110C. These cloud computing providers may provide access to large numbers of computing devices (often virtualized) with different configurations. For example, systems with one or more virtual CPUs may be offered in standard configurations with predetermined amounts of accompanying memory and storage. In addition to cloud computing providers 110A, 110B, and 110C, management server 140 may also be configured to communicate with bare metal computing devices 130A and 130B (e.g., non-virtualized servers), as well as a datacenter 120 including for example one or more high performance computing (HPC) systems (e.g., each having multiple nodes organized into clusters, with each node having multiple processors and memory), and storage systems 150A and 150B. Bare metal computing devices 130A and 130B may for example include workstations or servers optimized for machine learning computations and may be configured with multiple CPUs and GPUs and large amounts of memory. Storage systems 150A and 150B may include storage that is local to management server 140 as well as remotely located storage accessible through a network such as the internet. Storage systems 150A and 150B may comprise storage servers and network-attached storage systems with non-volatile memory (e.g., flash storage), hard disks, and even tape storage.

Management server 140 is configured to run a distributed computing management application 170 that receives jobs and manages the allocation of resources from distributed computing system 100 to run them. Management application 170 is preferably implemented in software (e.g., instructions stored on a non-volatile storage medium such as a hard disk, flash drive, or DVD-ROM), but hardware implementations are possible. Software implementations of management application 170 may be written in one or more programming languages or combinations thereof, including low-level or high-level languages, with examples including Java, Ruby, JavaScript, Python, C, C++, C#, or Rust. The program code may execute entirely on the management server 140, partly on management server 140 and partly on other computing devices in distributed computing system 100.

The management application 170 provides an interface to users (e.g., via a web application, portal, API server or command line interface) that permits users and administrators to submit applications/jobs via their workstations 160A, laptops 160B, and mobile devices, designate the data sources to be used by the application, designate a destination for the results of the application, and set one or more application requirements (e.g., parameters such as how many processors to use, how much memory to use, cost limits, application priority, etc.). The interface may also permit the user to select one or more system configurations to be used to run the application. This may include selecting a particular bare metal or cloud configuration (e.g., use cloud A with 24 processors and 512 GB of RAM).

Management server 140 may be a traditional PC or server, a specialized appliance, or one or more nodes within a cluster. Management server 140 may be configured with one or more processors, volatile memory, and non-volatile memory such as flash storage or internal or external hard disk (e.g., network attached storage accessible to management server 140).

Management application 170 may also be configured to receive computing jobs from user devices such as workstations 160A and laptops 160B, determine which of the distributed computing system 100 computing resources are available to complete those jobs, make recommendations on which available resources best meet the user's requirements, allocate resources to each job, and then bind and dispatch the job to those allocated resources. In one embodiment, the jobs may be applications operating within containers (e.g. Kubernetes with Docker containers) or virtualized machines.

Unlike prior systems, management application 170 may be configured with a low overhead system for performance data collection that monitors the impact of the performance data collection on the system and adjusts the sampling interval and which performance counters are collected based on the impact. It may also adjust the sampling interval and which performance counters are collected based on feedback received from other modules within management application 170, e.g., a system health monitor and a system security monitor. The management application may be configured to provide users with recommendations regarding suggested application changes and system configuration changes to improve application performance. This may be based not only on data collected for the particular application and the particular system in question, but also on aggregated data collected about many applications across many different systems and system configurations (e.g., with different numbers of processors, different memory configurations, bare metal, virtualized, etc.).

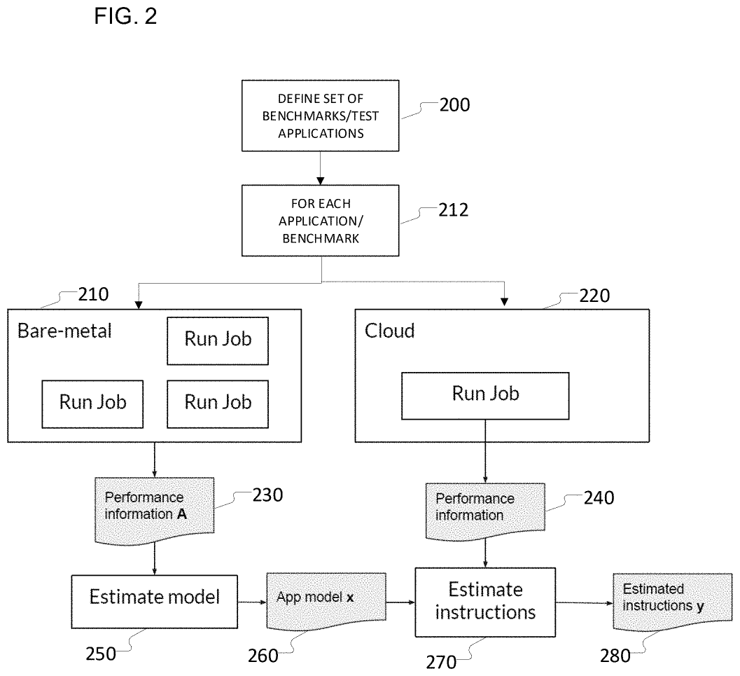

Turning now to FIG. 2, one example of a method for determining relative performance in cloud computing systems that may be implemented in the management application is shown. This is an example of one method that would consume potentially large amounts of performance data. As noted above, one of the main metrics for performance estimation is instructions per second. In order to measure instructions per second, one needs to count instruction events in the hardware. Due to security constraints, most of the instance configurations available on cloud services do not allow the user to measure hardware events such as instructions executed, cache-misses, branch-misses, etc. However, there are some other events that are typically available, e.g., task-clock, page-faults, and context-switches. Other performance-related metrics that are also typically available include CPU usage, memory usage, disk usage, and network usage.

Testing has shown that a correlation exists between hardware events such as instructions executed and these other system metrics/events available in the cloud. Based on such correlation, estimations of instructions per second can be determined. For example, machine learning-based methods can be used to estimate performance events from the available system metrics.

In FIG. 2, one example of a method for estimating performance in cloud computing systems is shown. First, a set of benchmarks are defined (step 200). For example, a set of benchmarks might include parsec benchmarks, Tensorflow bird classifier, Graph500, Linpack, and xhpcg. These benchmarks may also include actual user applications. The benchmarks may be single node or multinode. Each benchmark is then run (step 212), preferably multiple times, on different instance types. This includes bare metal instances (step 210) and non-metal cloud instances (step 220). The total number of runs may be large, as some cloud providers offer more than 200 different instance types including metal instances. For example, each benchmark may be run on a cloud provider on instances having: 2 processors with minimum RAM, 2 processors with maximum RAM, 4 processors with minimum RAM, 4 processors with maximum RAM, 8 processors with minimum RAM, etc. Performance data gathered from these benchmark runs on bare-metal instances (step 230) and cloud instances (step 240) is gathered and used to find one or more correlations between the hardware events and other system metrics or software events that are available on cloud instances. These correlations can be used to create a model (step 250) for each application 260. Then data from runs on cloud instances can be used to train a machine learning system (step 270), which can then be used to estimate hardware counter events 280 for applications on systems where these counter events are not accessible.

The benchmarks may be repeated a number of times (e.g., 5×) to increase the amount of data collected. A Pearson correlation coefficient may be calculated for all counters and system metrics. The counters that are significantly correlated with hardware events (both in general and for particular applications) may then be used to estimate the unavailable performance counter.

In general, only some performance software events are correlated with instructions (e.g., task-clock, page-faults, and context-switches), while others such as cache-misses do not correlate. Some correlations may be application dependent, so having a large number of benchmarks may improve the accuracy of predictions. While the correlations between counters may not be the same for all applications, there are some general patterns.

Based on test data, bare metal to cloud performance may be estimated based on an instructions counter. As noted above, an instructions counter is a useful performance measure available in bare metal systems that indicates how many instructions the processor has executed. Together with time stamps, this yields an instructions per second value that generally results in a good measure of system performance and can be used across systems to compare relative performance. The higher the instructions counter (i.e., the instructions per second), the higher the performance. Since the instructions counter is generally not available in virtualized environments running in a cloud, the instructions counter for virtualized cloud environments is predicted based on other counters typically available in those clouds.

To enable this prediction, a set of counters are measured on bare-metal (or metal instances on clouds which are configured to provide access to an instructions performance counter), and the collected data is used to build a machine learning (ML) regression system that estimates the instructions performance measure for other cloud instances (e.g., public clouds) based on a small subset of performance counters available on those cloud instances. Regression is a type of machine learning problem in which a system attempts to infer the value of an unknown variable (Y) from the observation of other variables that are related to the one the system is trying to infer (X). In machine learning regression systems, a sample data set (called a training set) is used. The training set is a set of samples in which the values for both the variable that is trying to be inferred (Y) and those variables that are related to that (X) are known. With the training set, the machine learning system learns a function or model (f) that relates or maps the values from X to Y (e.g., Y=f(X)). Once the function that maps the variables X with Y has been learned, then it is possible to infer the values of the variable Y from the observations of X.

The set of benchmarks used is preferably representative of many different types of applications. For example, in one embodiment multiple benchmarks from the following example list are utilized: Parsec benchmarks (e.g., blackscholes, bodytrack, facesim, freqmine, swaptions, yips, dedup, fluidanimate, x264, canneal, ferret, streamcluster), Tensor flow bird classifier, Linpak, graph500; and xhpcg. Other benchmarks and test applications are also possible and contemplated.

While many tools and techniques may be used to collect the performance data, one example is the perf stat tool, which is able to gather counter values at specified time intervals. The selected set of benchmarks may be executed with the perf stat tool running. Preferably, this is performed in multiple different cloud instances that are to be evaluated. Typically, cloud instances in cloud computing services are arranged by instance type and size (e.g., number of cores). If the instance type is large enough to fill the underlying hardware server (e.g., in AWS these instances are described as “metal”), then the security restrictions that prevent gathering performance counters are relaxed. This makes it possible to gather more performance counters on those instances as opposed to the severely limited set available in shared instances. In building the training set for the system, it is desirable to run the selected set of benchmarks on at least some of the cloud instances that permit access to the larger set of performance counters.

Test data indicates that the instructions performance counter is highly related to other counters that are usually available, e.g., cycles, page-faults, and context-switches. As the relationship between them can be application specific, in one embodiment the system is configured to determine the relationship between the accessible counters and the desired but inaccessible instruction counter on a per benchmark (i.e., per application) basis. These measured relationships can then be used to predict the instructions counter on shared instances in public cloud systems where the instructions counter is not available.

While in some embodiments benchmarks may be combined to provide overall system-level relative performance rankings, for application-specific recommendations it may be preferable to model each benchmark separately, e.g., for each of the benchmarks a different x vector may be calculated to model the relationship between the available counters and the unavailable but desirable instructions counter. To predict the instructions counter on a cloud with limited access to performance counters, the application for which the estimate is being performed is matched to one of the available benchmarks having been previously run. The learned model from that benchmark is then used to predict an estimated instruction counter (e.g., as y=Ax). In order to match applications, it may be preferable to conduct at least one run with all performance counters available for that application. From that run, a normalized histogram of performance counters can be created. The normalized histograms may be computed from the quotient of different counters and may be normalized, such that concatenating all the histograms for a given application/benchmark provides a feature vector (i.e., a performance counters spectral signature) that can be used to perform application matching.

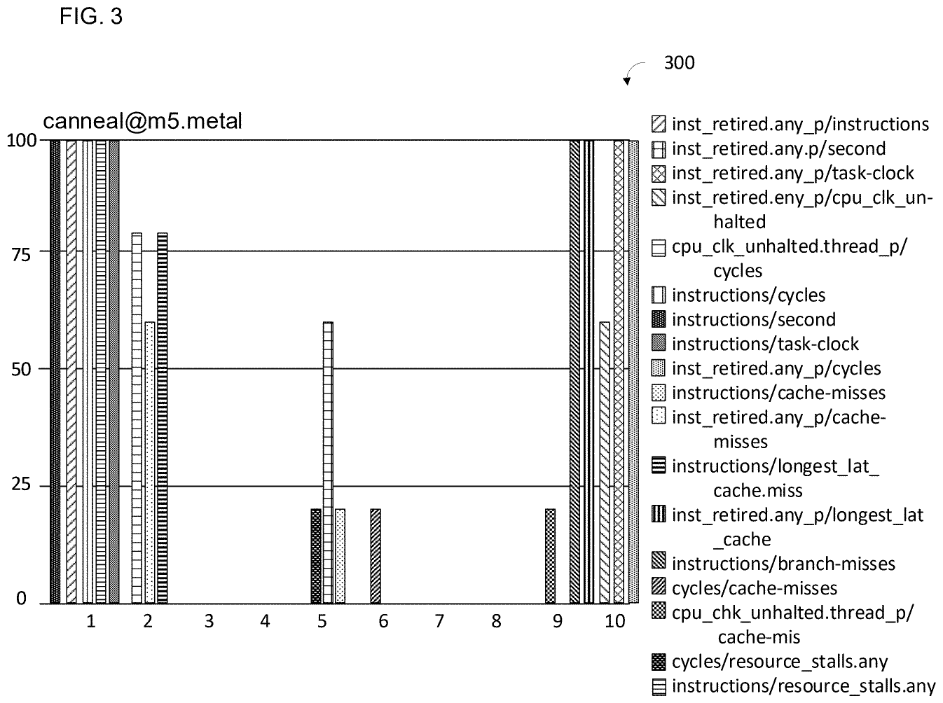

One such example histogram 300 is shown in FIG. 3, which is based on test data for the canneal benchmark on a full server bare metal cloud instance. These histograms may be used in matching a user's application to one of the tested benchmarks. To perform the application to benchmark matching, in one embodiment a metric to measure differences (e.g., distances) between applications may be used (e.g. least squares), and the benchmark closest to the user's application may be used.

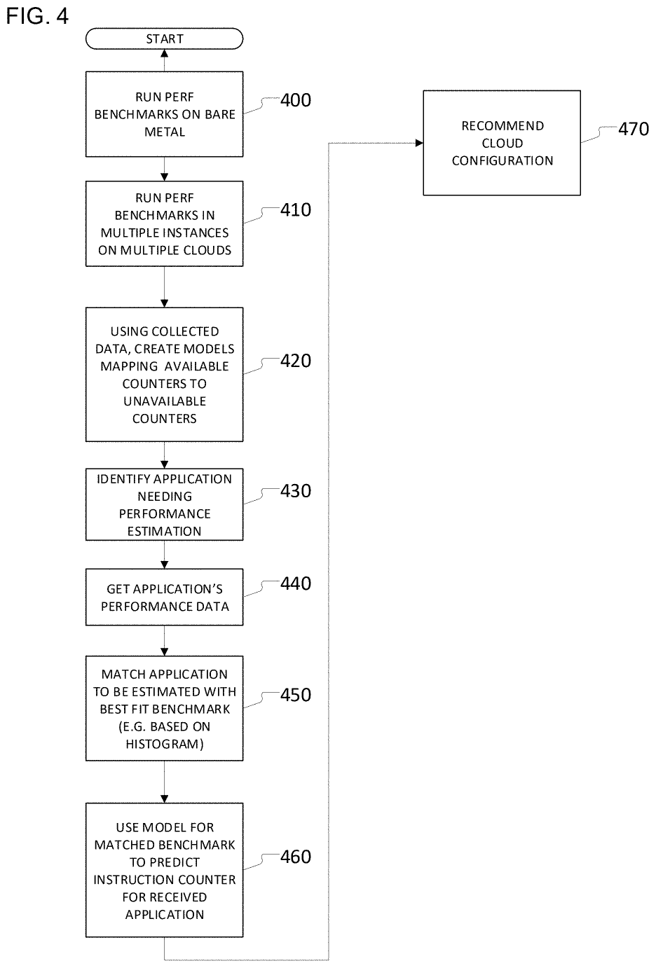

Turning now to FIG. 4, a flowchart of an example embodiment of a method for recommending a cloud configuration based on estimated performance counters is shown. In this embodiment, benchmarks are run on bare metal systems (step 400) and on multiple cloud instances on multiple different clouds (step 410). Data is collected and used to create models that map available counters on cloud systems to the desired but unavailable performance counters such as the instructions counter (step 420). When a user specifies an application that they have previously run on bare metal and want to run on the cloud (step 430), the user is prompted for performance data (step 440) the user has observed on the bare metal run. For example, the user may specify what the perf tool measured as instructions per second when they ran their application on their local development workstation on a test data set. The application may also be matched to one of the existing benchmarks that have been run (step 450). This matching may be based on application histograms, the libraries used by the application, the data sets used by the application, or other application-specific data or metadata. The model created earlier for the matching benchmark is then used to predict cloud performance counters for the application (step 460), and a recommendation is made (step 470). The recommendation may be for the fastest performance (e.g., within a given budget specified by the user), or for a best match to their current bare metal system's performance.

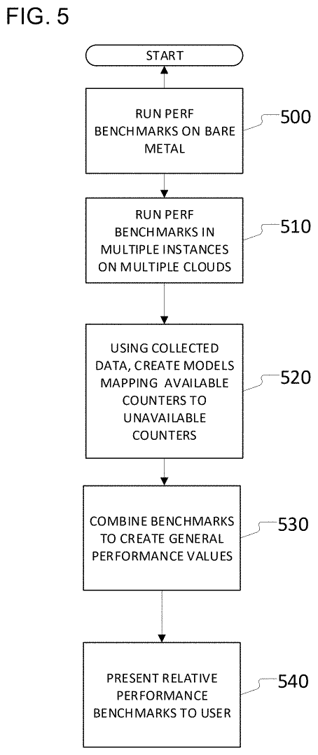

Turning now to FIG. 5, a similar method may be used to provide general relative performance measures to users separate from a particular application. In this example embodiment, benchmarks are run on bare metal systems (step 500) and on multiple cloud instances on multiple different clouds (step 510). Data is collected and used to create models that map available counters on cloud systems to the desired but unavailable performance counters such as the instructions counter (step 520). These benchmark-specific values may then be combined (e.g., averaged) to generate overall relative performance values for each cloud configuration (step 530). These may then be presented to users (step 540), e.g., in a ranking system based on estimated instructions per second, to help them make informed decisions regarding which cloud and cloud instance configuration best fits their performance needs (e.g., when moving from one cloud instance to a different cloud).

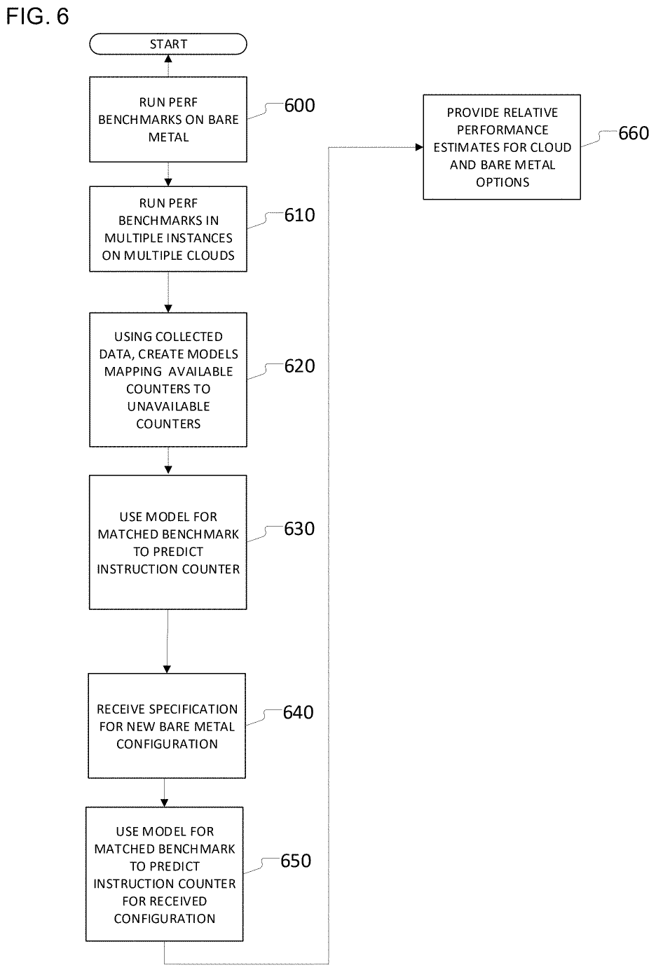

Turning now to FIG. 6, a flowchart of an example embodiment of a method for providing relative performance estimates for cloud and bare metal configurations is shown. In this embodiment, given a cloud performance benchmark, a prediction model is created to predict performance of a bare metal platform relative to an existing cloud instance. This may be helpful for data scientists using a cloud instance and considering migrating their application to an on-premises bare metal system. As with prior examples, benchmarks are run on bare metal systems (step 600) and on multiple cloud instances on multiple different clouds (step 610). Data is collected and used to create models that map available counters on cloud systems to the desired but unavailable performance counters such as the instructions counter (step 620). The model is used to predict a performance counter for the user's existing cloud instance (step 630). Next, the user is prompted to specify the bare metal system they are considering (step 640). The user may for example, select the system from a list of already profiled bare metal systems, or provide data from the perf tool for one or more benchmarks (e.g., as provided by the system manufacturer). Based on these inputs, the relative performance of the cloud instance and bare metal systems may be used to predict an instruction counter for the received configuration (step 650) and relative performance estimates may be presented to the user (step 660).

In one embodiment, the model may be created using linear regression analysis with a positive coefficients constraint. For example, let A be a matrix in which the columns store the values of the cycles, page-faults, context-switches, or any other available performance-related counter for shared instances that are related to the instructions counter. One additional column may be added that is filled with ones for the bias. Let B be a column vector which store the associated instructions gathered for the counters in matrix A at different time intervals for a specific application. A column vector x is then estimated which minimizes the squared error between Ax and b, subject to the components of x being positive (i.e., x(i)>0 for all i). This is shown in the formula below, wherein Matrix A represents a matrix with the observed counters available in the cloud, Vector y represents the instructions associated to those counters, and the x vector contains the coefficients that define the relationship between A and y:

min∥Ax−y∥², subject to: xᵢ≥0,∀i

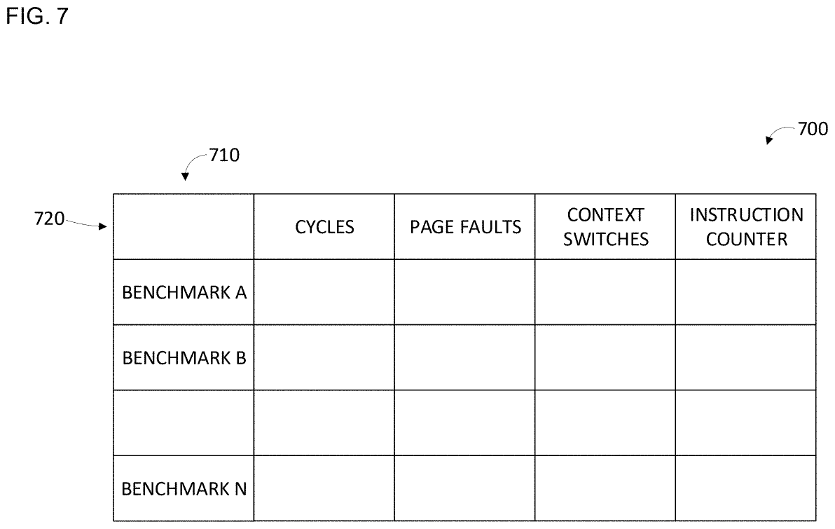

Turning now to FIG. 7, a diagram illustrating an example matrix 700 usable for estimating performance for cloud and bare metal systems is shown. While other matrix configurations are possible and contemplated, in this example, each row 720 stores data for a different benchmark (or different run if multiple runs per benchmark are available), as indicated by column 710. Each column stores the values gathered for a particular counter. In some embodiments, not all systems may be tested, but based on the existing data for similar tested instance configurations, predictions may still be made.

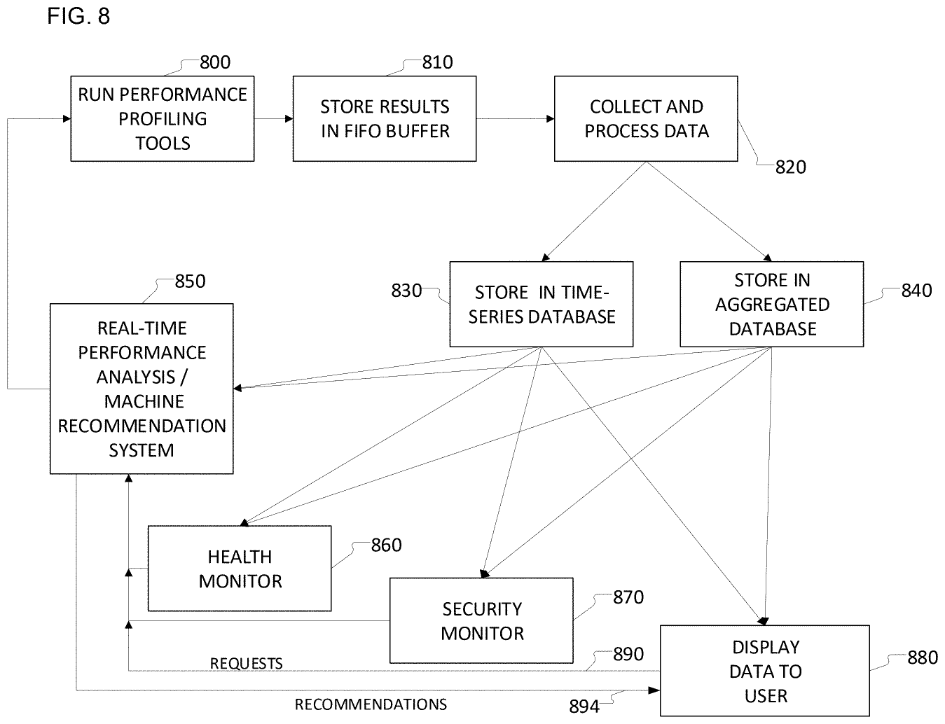

Turning now to FIG. 8, a flowchart illustrating one example embodiment of a scalable and low overhead method for collecting performance data is shown. This method may be configured to work with custom developed performance profiling tools and with existing off-the-shelf performance tools like Linux perf. This is because this method does not require special modification of the tools used.

One or more performance profiling tools (e.g., Linux perf tool) are launched in connection with running an application or benchmark (step 800). As results are generated, they are temporarily stored in a FIFO (first-in first-out) buffer (step 810). When the data from the profiling tool arrives, it is removed from the FIFO buffer by the data collection processor and is processed (step 820). This processing may include for example formatting the data so it can be stored in a time series database (step 830) and aggregating the data so it can be stored in an aggregated database (step 840). For example, for each job all collected samples may be aggregated (e.g., combined via time-weighted averaging based on application phases such as data fetching, pre-processing, processing, post-processing) and stored in the aggregated database. In some embodiments a machine learning algorithm may be used to learn to aggregate (e.g., a cascade-correlation approach). When there is no correlation between performance data samples, a simple neural network can be used that will learn the aggregate functions (e.g., using some standard TensorFlow functions).

The newest information may also be saved in an unaggregated format for real time performance analysis in the time-series database. Access to the databases may be provided to the user (step 880). For example, on occasion the user may wish to invoke an expert mode to see the performance data directly. The user may also provide requests 890 to the real-time performance analysis engine (e.g., to increase resolution or add a particular performance counter of interest for a particular application). However, the real-time performance analysis engine and machine recommendation system 850 may also provide recommendations 894 back to the user regarding optimizations that the user may want to consider for either their application (e.g., which library to use) or the configuration for the computing system (e.g., the amount of memory allocated).

Real-time performance analysis engine and machine recommendation system 850 may be configured to use machine learning (ML) to process the data in the databases to generate the recommendations 894. For example, MapReduce or Spark may be used to compute a covariance matrix based on the performance data captured. Other modules such as a system health monitor 860 and system security monitor 870 may also be configured to access the databases and send requests to the real-time performance analysis engine and machine recommendation system 850 for additional data. For example, if system security monitor 870 detects a potential threat, it may request certain performance data at a high frequency in order to better determine if the threat is real. Similarly, if system health monitor 860 detects a possible system health issue, it may request additional performance data (e.g., certain counters to be recorded at a certain interval or frequency).

Since the newest information may be kept at a high frequency sampling rate, the user has the ability to check the job performance on a real time basis using both aggregated information (i.e., based on the whole job execution aggregated up to a current point in time) and also the high frequency sampling of the most recent period (e.g., the last few minutes). The time-series database may be configured to contain only a small window (e.g., the last few minutes) of the job execution or it may be configured to contain a larger window, up to one that includes all the samples collected. However, the last option can be very expensive in terms of storage and queries for the job statistics from the time-series database. Preferably, the window of the high frequency data is set to be small enough to not impact the job execution. Although the amount of data required to store all the profiling data may be large, it is produced at a low pace and therefore should not negatively impact system performance. For the example presented above, all the 10,000 MPI processes will produce only ˜800 KB per second (e.g. [10,000 procs]×[100 counters]×[50 bytes per counter]/[60 seconds]=˜800 KB/s).

Data from the two databases may be displayed directly to the user (step 880) interactively or passively, and the data may also be used by real-time performance analysis engine and machine recommendation system 850 for performing real-time performance analysis and for making recommendations as described above. For example, if the application is determined to be repeatedly waiting for data access from storage, a recommendation to change the system configuration to one with more system memory or higher storage bandwidth and lower storage latency may be made.

Advantageously, in some embodiments real-time performance analysis engine and machine recommendation system 850 may measure the impact of performance monitoring and apply policies. For example, one policy may be to not allow performance monitoring to have more than X % impact on application performance for normal priority applications, and do not permit more than Y % impact for applications identified as high priority. To prevent a greater impact, the polling interval may be throttled. Real-time performance analysis engine and machine recommendation system 850 may use machine learning-guided algorithms to determine when to collect more or less performance data and may intermediate between requests for data from a user, and security and health monitors.

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such elements. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” and “for example” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example, and without limitation, uses of “and” do not necessarily require all elements or features listed, and uses of “or” are inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

All matter contained in the above description or shown in the accompanying drawings shall be interpreted as illustrative only and not limiting. Changes in detail or structure may be made without departing from the present disclosure.

It should be understood that a computer, a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

It should be further understood that an article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. A method for managing performance data, the method comprising:
executing a performance profiling tool on a computing system;
executing an application on the computing system;
collecting performance data about the application from the performance profiling tool;
storing the performance data in a database;
monitoring an impact of the performance profiling tool on the application; and
adjusting an interval at which the performance profiling tool operates in order to keep the impact of the performance profiling tool on the application below a predetermined policy threshold.

2. The method of claim 1, further comprising:
providing the performance data to one or more system monitors;
receiving feedback from the system monitors; and
adjusting the interval at which the performance profiling tool operates based on the feedback.

3. The method of claim 1, further comprising:
providing the performance data to one or more system monitors;
receiving feedback from the system monitors; and
adding or removing one or more performance measures from being collected based on the feedback.

4. The method of claim 2, wherein one of the system monitors is a system health monitor.

5. The method of claim 2, wherein one of the system monitors is a system security monitor.

6. The method of claim 2, further comprising providing recommendations to a user regarding application optimizations based on the performance data stored in the database.

7. The method of claim 2, further comprising aggregating the performance data in the database.

8. A method for estimating performance on cloud computing systems, the method comprising:
executing a plurality of performance benchmarks on a plurality of cloud computing systems and bare metal computing systems to collect performance counter data,
storing the performance counter data into a FIFO buffer;
reading the performance counter data out of the FIFO buffer;
storing a time-limited window of the performance counter data into a time-series database;
aggregating the performance counter data; and
storing the aggregated performance counter data into an aggregated database.

9. The method of claim 8, further comprising performing real-time performance analysis on the performance counter data in the time-series database and the aggregated database.

10. The method of claim 8, further comprising making recommendations to a user based on the performance counter data in the time-series database and the aggregated database.

11. The method of claim 8, wherein the performance counter data comprises a set of normally available counters and one or more normally unavailable counters.

12. The method of claim 9, further comprising providing a user with access to the time-series database and the aggregated database simultaneously for real-time and aggregated performance analysis.

13. The method of claim 11, wherein the performance counter data comprises instruction counters, cycle counters, page-faults, and context-switches.

14. The method of claim 12, wherein the real-time performance analysis comprises creating histograms of the performance counter data.

15. A non-transitory, computer-readable storage medium storing instructions executable by a processor of a computational device, which when executed cause the computational device to:
execute a performance profiling tool on a computing system;
execute an application on the computing system;
collect performance data about the application from the performance profiling tool;
store the performance data in a database;
monitor an impact of the performance profiling tool on the application; and
adjust an interval at which the performance profiling tool operates in order to keep the impact of the performance profiling tool on the application below a predetermined policy threshold.

16. The non-transitory, computer-readable storage medium of claim 1515, which when executed further causes the computational device to:
provide the performance data to one or more system monitors;
receive feedback from the system monitors; and
adjust the interval at which the performance profiling tool operates based on the feedback.

17. The non-transitory, computer-readable storage medium of claim 1515, which when executed further causes the computational device to:
provide the performance data to one or more system monitors;
receive feedback from the system monitors; and
add or remove one or more performance measures from being collected based on the feedback.

18. The non-transitory, computer-readable storage medium of claim 16, wherein one of the system monitors is a system health monitor.

19. The non-transitory, computer-readable storage medium of claim 16, wherein one of the system monitors is a system security monitor.

20. The non-transitory, computer-readable storage medium of claim 1515, which when executed further causes the computational device to provide recommendations to a user regarding application optimizations based on the performance data stored in the database.
